(19) United States
(12) Patent Application Publication
(10) Pub. No.: US 2006/0152773 A1
(43) Pub. Date: Jul. 13, 2006

(54) Book scanner with portable stoarage device

(75) Inventor: Yung-Chuan Wu, Hsin-Chu City (TW)

Correspondence Address: CHARLES E. BAXLEY, ESQ., 90 JOHN STREET, THIRD FLOOR, NEW YORK, NY, 10038, US

(73) Assignee: Avision Inc.

(21) Appl. No.: 11/235,867

(22) Filed: Sep. 27, 2005

(30) Foreign Application Priority Data
Jan. 13, 2005 (TW) 094100937

(51) Int. Cl. H04N 1/04

(52) U.S. Cl. 358/474

(57) ABSTRACT

The invention provides a book scanner, connecting to a portable storage device, comprising a housing, two scan windows, at least an optical apparatus and at least a data output device. The two scan windows are assembled together in an inclined manner to form an upraised ridge, so that the pages of an open book can be placed flatly on the scan windows and can be clearly scanned. Furthermore, the scan image data can be transmitted directly to the portable storage device, thus making it more convenient for a user to carry and access the scan image data.

### BACKGROUND OF THE INVENTION

1. Field of the Invention

The present invention relates to a scanner, and more particularly to a book scanner electrically connected to a portable storage device. After a document is scanned, the scan image data of the document can be transmitted directly to the portable storage device, making it convenient for a user to carry and access the scan image data.

2. Description of the Prior Arts

As for the storage of images, the images stored in digital format takes less space to retain and last longer than the files stored in paper form; therefore, the scanners has been widely used as a digital image input device.

A conventional flatbed scanner scan one single sheet of a document at a time and requires users to place the sheet manually on a platform of the scanner, while a scanner with an automatic paper feeder can scan a stack of sheets continuously and automatically without any interruption.

As for a document of only a single sheet, both of the flatbed scanner and the scanner with the automatic paper feeder are able to acquire the image data of the document efficiently. However, if multiple documents or sheets are bound together, then the automatic paper feeder will be useless since it has no automatic paper-dividing function.

Although the bound documents can be turned page by page manually when being scanned by the flatbed scanner, it still impossible to place the documents flatly against the scan window. As a result, deformation of the scan image would occur. Therefore, the flatbed scanner is not ideal for scanning the bound documents.

In addition, the image data acquired by the scanner will be transmitted to and stored in a computer, such as in the hard disc or other portable storage devices linked to the computer, such as a floppy disc, a compact disc and the like. However, The aforementioned scanner allows users to carry the image data only through operation of a corresponding computer program, thus causing inconveniences.

If the image data acquired by the scanner can be directly transmitted to a portable storage device, then the scanner does not need to be linked to a computer. For example, TW Patent 370760 discloses a flatbed scanner with portable storage device, which comprises a charge-coupled device, CCD, or a contact image sensor, CIS. U.S Pat. No. 5,574,274 discloses a transmissive/reflective scanner and a sheet-fed scanner. Nonetheless, the above-mentioned scanners are only suitable for scanning the non-bound documents

The present invention has arisen to mitigate and/or obviate the afore-described disadvantages.

### SUMMARY OF THE INVENTION

The primary objective of the present invention is to provide a book scanner connected to a portable storage device and capable of transmitting scan image data directly to the portable storage device.

The book scanner includes two inclined scan windows that are assembled together to form an upraised ridge, so that the pages of an open book can be placed flatly against the scan windows and can be clearly scanned.

The portable storage device can be an external floppy disc driver, an external optical disc driver, an external memory card or a memory stick, a PDA (personal digital assistant), a computer laptop, and etc.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a book scanner in accordance with a first preferred embodiment of the present invention;

FIG. 2 shows the internal structure of the book scanner;

FIG. 3 shows the operation steps of the present invention;

FIG. 4 shows a book scanner in accordance with a second preferred embodiment of the present invention;

FIG. 5 shows a book scanner in accordance with a third preferred embodiment of the present invention.

### DETAILED DESCRIPTION OF THE PREFERRED EMBODIMENTS

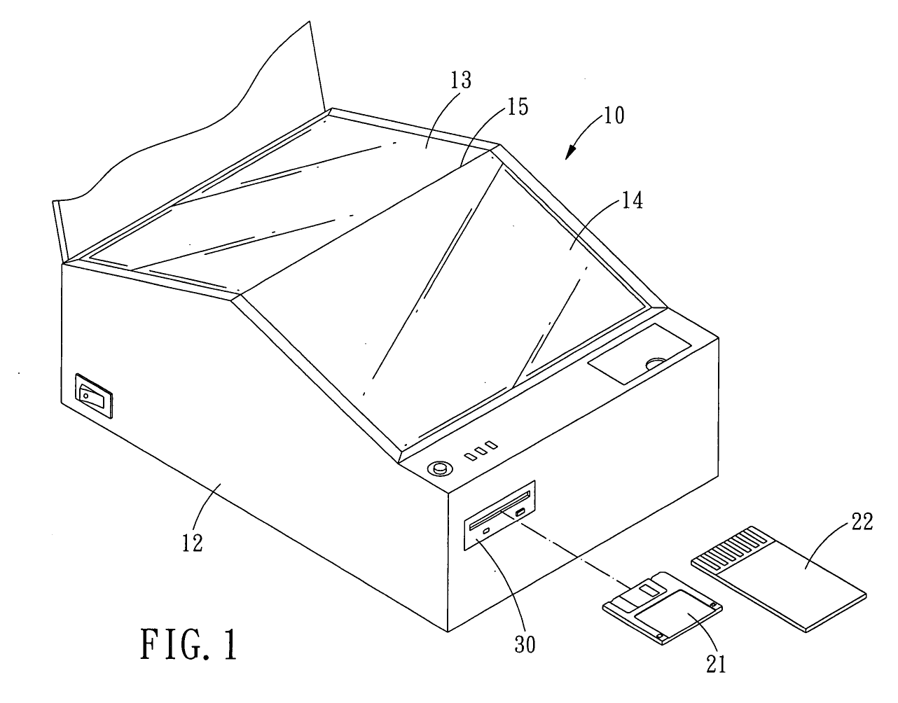

Referring to FIG. 1, which shows a book scanner 10 connected to portable storage devices 21, 22 in accordance with a first preferred embodiment of the present invention. The book scanner 10 includes a housing 12 on which are disposed two scan windows 13, 14 that are inclined to each other to form an angle and are connected at a ridge 15.

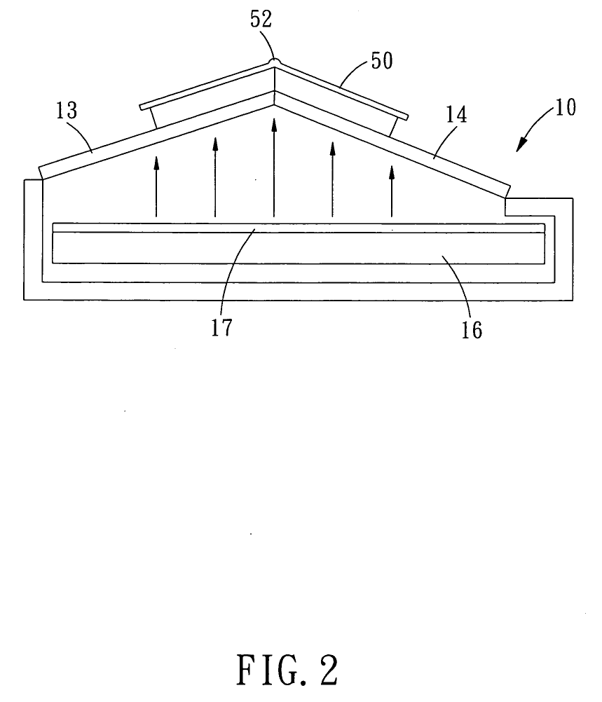

FIG. 2 shows the internal structure of the book scanner 10. In the housing 12 is disposed an optical apparatus 16 that is located beneath the scan windows 13, 14. The optical apparatus 16 is able to move in a direction parallel to the ridge 15 and comprises a light source 17 providing scanning light, a reflective mirror assembly, a lens, and an optical sensor, such as a charge-coupled device, CCD, or a contact image sensor, CIS.

Referring to FIG. 1, the housing 12 is provided with a data output device 30, such as an insertion-type storage device 30 as shown, which allows the portable storage devices 21, 22 to be inserted to access the data. The portable storage devices 21, 22 can be 3.5-inch magnetic discs having different storage volume, or can be different types of memory cards.

As shown in FIG. 2, in operation, the book 50 is opened and placed on the scanner 10, and the pages are placed on the scan windows 13, 14. Because the scan windows 13, 14 are connected together in an inclined manner and the ridge 15 is aligned to the binding portion 52 of the book 50, the pages of the book 50 can be placed flatly against the surface of the windows 13, 14.

After the optical apparatus 16 scans the content of the book 50, the scan content is stored in a temporary memory device and then outputted to the portable storage devices 21, 22 through the data output device 30.

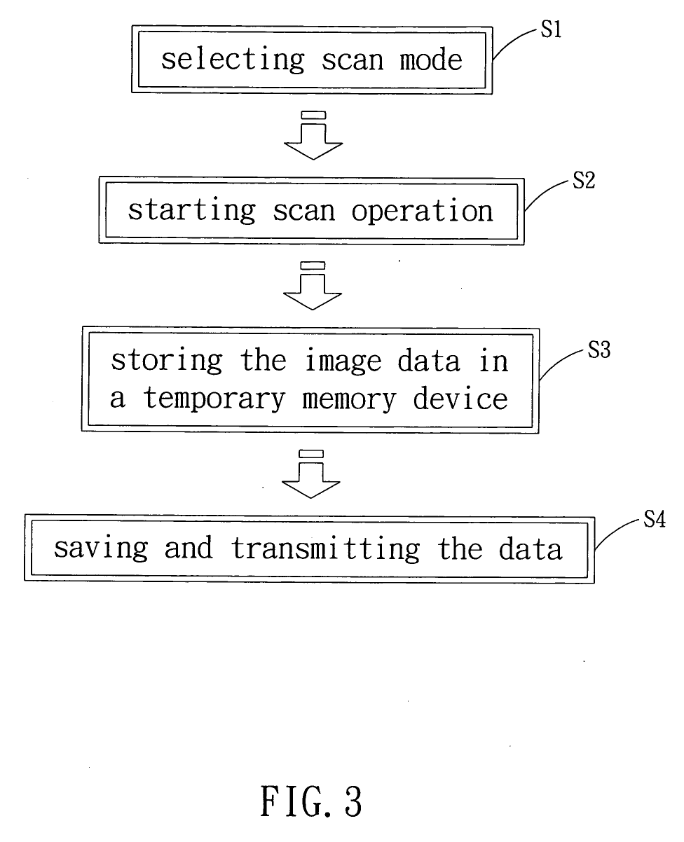

In other words, the operation of the present invention is illustrated in FIG. 3 and comprises the following steps:

S1: selecting scan mode: including selections of black/white/gray level, resolution and scan scope;

S2: starting scan operation by driving the optical apparatus 16 to scan according to the conditions of S1;

S3: storing image data in a temporary memory device;

S4: outputting the image stored in the temporary memory device to a portable storage device.

In the aforementioned embodiment, the scanner 10 is suitable for use in a library or a data management center where a large number of books are stored, since it is designed particularly aiming at the documents that are bounded. By using the book scanner 10, the user can scan the content of a book and store it in the portable storage devices 21, 22 immediately.

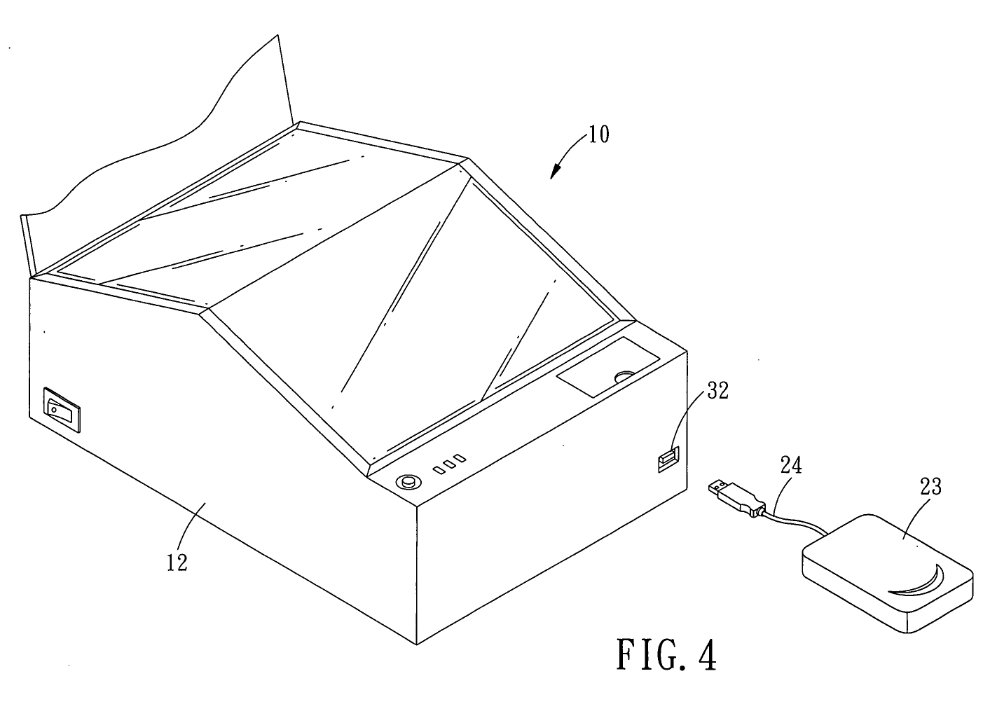

Referring to FIG. 4, which shows a combination of a book scanner 10 and a portable storage device 23 in accordance with another embodiment of the present invention. The book scanner 10 in this embodiment is structurally similar to that of the previous embodiment, except that:

The data output device of the housing 12 is a port 32.

The portable storage device 23 can be electrically connected to the port 32 via a cable 24. The aforementioned portable storage device 23 can be an external floppy disc driver, an external optical disc driver, an external memory card or stick, a PDA (personal digital assistant), a computer laptop, and etc.

Besides, the port 32 also allows connection with a flash disc without requiring the cable 24 to provide electric connection. And the operation of the book scanner of this embodiment is the same as that of the first embodiment.

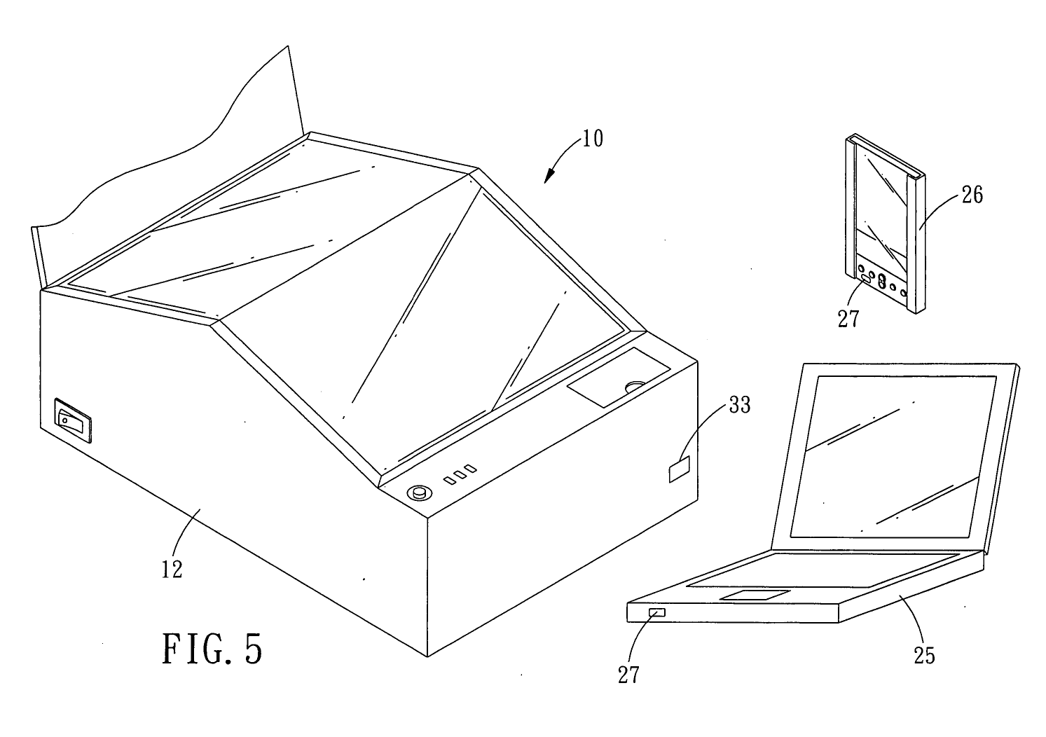

Referring to FIG. 5, which shows a combination of a book scanner 10 and a portable storage device 23 in accordance with another embodiment of the present invention. The book scanner 10 in this embodiment is structurally similar to that of the previous embodiment, except that:

The data output device of the housing 12 is a transmitting terminal 33 of a wireless transmission device, and the portable storage devices 25 and 26 are equipped with a receiving terminal 27 of the wireless transmission device, so that the data also can be transmitted from the scanner 10 to the portable storage devices 25, 26 through wireless transmission. The portable storage devices 25, 26 can be a computer laptop or a PDA. And the operation of the book scanner 10 of this embodiment is the same as that of the first embodiment.

The design concept of the above-mentioned embodiments is to provide a book scanner 10 capable of overcoming the problem which occurs when the book 50 or a document bound in volume is being scanned by a flatbed scanner. By taking advantages of two scan windows 13, 14 which are connected in an inclined manner, the pages of the book 50 can be placed flatly on the scan windows and can be clearly scanned. The scanner 10 is further provided with different portable data storage devices for storage of the output data of the scanner 10. In other words, the present invention not only overcomes the problem, but also allows the image data scanned by scanner to be directly saved in a portable storage device.

While we have shown and described various embodiments in accordance with the present invention, it should be clear to those skilled in the art that further embodiments may be made without departing from the scope of the present invention.

What is claimed is:

1. A book scanner with a portable storage device comprising:
a housing;
two scan windows disposed on the housing and assembled together in an inclined manner to form an upraised ridge;
at least an optical apparatus moveably disposed beneath the two scan windows in the housing for providing scanning light source and generating a scan image data of a document placed on the two scan windows; and
at least a data output device installed on the housing for outputting the scan image data to a portable storage device.

2. The book scanner with a portable storage device as claimed in claim 1, wherein the housing is interiorly equipped with a temporary memory device for temporarily storage of the scan image data.

3. The book scanner with a portable storage device as claimed in claim 1, wherein the data output device is an insertion-type storage device where the portable storage device is inserted to access the scan image data.

4. The book scanner with a portable storage device as claimed in claim 3, wherein the portable storage device takes the form of floppy discs of different capacities.

5. The book scanner with a portable storage device as claimed in claim 3, wherein the portable storage device takes the form of memory cards of different capacities.

6. The book scanner with a portable storage device as claimed in claim 1, wherein the data output device in the housing is a port for electric connection with the portable storage device.

7. The book scanner with a portable storage device as claimed in claim 6, wherein the portable storage device is a combination of a floppy disc driver and a floppy disc.

8. The book scanner with a portable storage device as claimed in claim 6, wherein the portable storage device is a combination of an optical disc driver and an optical disc.

9. The book scanner with a portable storage device as claimed in claim 6, wherein the portable storage device is a flash disc.

10. The book scanner with a portable storage device as claimed in claim 6, wherein the portable storage device is a PDA.

11. The book scanner with a portable storage device as claimed in claim 6, wherein the portable storage device is a computer laptop.

12. The book scanner with a portable storage device as claimed in claim 1, wherein the data output device takes the form of wireless transmission device, and the portable storage device is also equipped with a wireless transmission device, so that the scan image data is allowed to be transmitted from the book scanner to the portable storage device through wireless transmission.

13. The book scanner with a portable storage device as claimed in claim 12, wherein the portable storage device is PDA.

14. The book scanner with a portable storage device as claimed in claim 12, wherein the portable storage device is a computer laptop.
